(19) United States
(12) Patent Application Publication
(10) Pub. No.: US 2016/0292558 A1
(43) Pub. Date: Oct. 6, 2016

(54) ELECTRONIC TICKET-IN TICKET-OUT VOUCHER AND SYSTEM

(71) Applicant: Nanoptix Inc., Dieppe (CA)

(72) Inventors: Daniel Vienneau, Dieppe (CA); Michel Vienneau, Dieppe (CA)

(21) Appl. No.: 15/089,389

(22) Filed: Apr. 1, 2016

Related U.S. Application Data
(60) Provisional application No. 62/142,409, filed on Apr. 2, 2015.

(51) Int. Cl. G06K 19/07; G06K 19/02; G06K 19/06

(52) U.S. Cl. CPC G06K 19/0723; G06K 19/06028; G06K 19/025

(57) ABSTRACT

An electronic Ticket-In Ticket-Out voucher and system for use in the transfer of credit between a gaming machine in a gaming establishment. The system eliminates the cost of continual printing and labor costs while decreasing the environmental impact. Each electronic ticket-in ticket-out (e-TITO) voucher contains a reprogrammable electronic display that displays mandatory information to operate within a gaming machine along with a Radio Frequency Identification (RFID) tag to connect to the gaming establishment's servers.

### BACKGROUND

1. Field

The present invention relates to the field of electronic ticket vouchers and systems, and more specifically electronic ticket-in ticket out vouchers and systems allowing the transfer of credit between gaming machines at gaming establishments.

2. Background

The gaming machine manufacturing industry provides a variety of gaming machines and gaming tables for the amusement of patrons at a gaming establishment. Fifteen years ago, the gaming industry introduced the ticket-in ticket out (TITO) concept, replacing Coin Hoppers with Printed vouchers enabling the transfer of credit from one gaming machine to another by inserting and validating these vouchers via the bill Validators. Cashless enabled games used in cashless enabled gaming are so named because they can conduct financial exchanges using a mixture of traditional currencies and vouchers. When a player cashes out using a cashless enabled game such as a slot machine operably connected to a cashless system and the system may determine the type of pay out presented to the player.

Today, the vast majority of Casinos in the world are printing TITO vouchers when cashing out. Since then, millions of dollars of coin handlings is saved every year. Printing millions of TITO tickets, now represent thousands of tons of paper, coated with chemicals, being disposed. It is only a matter of time before gaming establishments will be forced to evaluate greener alternatives.

Inventions such as U.S. Pat. No. 6,340,331 (Saunders), U.S. Pat. No. 8,414,382 (Denham), and U.S. Pat. No. 8,613,659 (Nelson) have been devised in order to provide a means of cashless exchange of funds between gaming machines and tables.

Specifically, Saunders discloses a cashless peripheral device connecting to a gaming system. The gaming machine, which is part of the gaming system, issues a cash-out signal when a player quits playing and receives a cash-in signal when a player desires to play a game in the gaming machine. The gaming system comprises of a number of gaming machines interconnected to a central computer. Each gaming machine contains a stack of continuous unprinted tickets, which is used to print out a coded value, such as a bar coded value, on a ticket in response to a cash-out signal initiated by the player. Saunders provides the player with a more convenient form of issuing funds so that the player can walk away from a game with a physical item and the satisfaction of winning from a particular game. The problem with Saunders is that it provides the player with a printed ticked upon cashing-out. Printed tickets are not environmentally friendly as they represent thousands of tons of paper, and are coated with chemical ink.

Denham discloses a secured gaming table vouchering system to enable the use of game vouchers and cashless gaming at gaming tables. The system, which is interconnected by a central computer allows the expansion of credit transfer within a gaming establishment to include gaming tables. Denham provides for the gaming establishment to allow players a seamless transition between all gaming points. As with Saunders, Denham provides the player with a printed ticket upon cashing-out, thereby damaging the environment with paper waste and chemical ink.

Nelson's disclosure attempts to alleviate the environmental effects of printed tickets in the gaming industry by providing a gaming system compatible with patron-controlled portable electronic devices, such as a smart phone or tablet computers. In one embodiment, Nelson system can be configured to issue a virtual ticket voucher to a patron-controlled portable electronic device. The portable electronic devices can be configured to store and transmit virtual ticket voucher information to an electronic gaming machine or a redemption kiosk and receive a virtual ticket voucher. The electronic gaming machine can include one or more wireless interfaces and can be configured to communicate using one more different wireless communication protocols. Although Nelson eliminates the environmental impact of printed ticketing, it leaves the gamer without a physical item and the satisfaction of winning from a particular game. There are also significant labor costs result from using a wireless virtual ticket-in and ticket-out system. Wireless interfaces are required to be installed and maintained, and significant steps would be required to maintain security of the wireless systems. Additionally, Nelson predetermines that players have or are willing to carry portable electronic devices at gaming establishments.

A need exists for a cost effective and environmentally conscious system for ticket-in and ticket-out gaming machines. There is a need for a low cost low power media that can be re-writable and still offer the security that exists today in the gaming industry. The media needs to be a self-contained electronic device, similar to the size of a U.S. currency bill and almost the same thickness as the current ticket-in ticket-out tickets. That way the new system can replace the existing ticket-in ticket-out tickets without drastically changing the control systems and infrastructure currently used by the gaming industry.

### SUMMARY

In one aspect, the present disclosure provides for an electronic ticket voucher comprising an electronic display to dynamically display ticket information; a radio frequency identification tag to wirelessly communicate a unique ticket identifier; a contact surface further comprised of: a first end electrically connected to the electronic display to send display instructions; and, a second end to provide an electrical connection to a programming an reading module to receive display instructions.

In another aspect, the present disclosure provides for an electronic ticket-in and ticket-out system for use in a gaming machine comprising: an electronic ticket voucher further comprised of: an electronic display to dynamically display ticket information; and, a radio frequency identification tag to wirelessly communicate a unique ticket identifier; a programming and reading module electrically connected to the ticket voucher and the gaming machine to receive information from the gaming machine and instruct the voucher to display corresponding ticket information; and, a radio frequency identification module in wireless communication with the radio frequency identification tag to receive the unique ticket identifier and relay the unique ticket identifier to the gaming machine.

### BRIEF DESCRIPTION OF THE DRAWINGS

It will now be convenient to describe the invention with particular reference to one embodiment of the present invention. It will be appreciated that the drawings relate to one embodiment of the present invention only and are not to be taken as limiting the invention.

FIG. 1 is a front view of an electronic ticket-in ticket-out voucher, according to one embodiment of the present invention.

FIG. 2 is a representative schematic of the electronic ticket-in ticket-out voucher interacting with a system including a programming and reading module, according to one embodiment of the present invention.

### DETAILED DESCRIPTION

The present invention will now be described more fully hereinafter with reference to the accompanying drawings, in which preferred and other embodiments of the invention are shown. No embodiment described below limits any claimed invention and any claimed invention may cover processes or apparatuses that are not described below. The claimed inventions are not limited to apparatuses or processes having all the features of any one apparatus or process described below or to features common to multiple or all of the apparatuses described below. It is possible that an apparatus or process described below is not an embodiment of any claimed invention. The applicants, inventors or owners reserve all rights that they may have in any invention claimed in this document, for example the right to claim such an invention in a continuing application and do not intend to abandon, disclaim or dedicate to the public any such invention by its disclosure in this document.

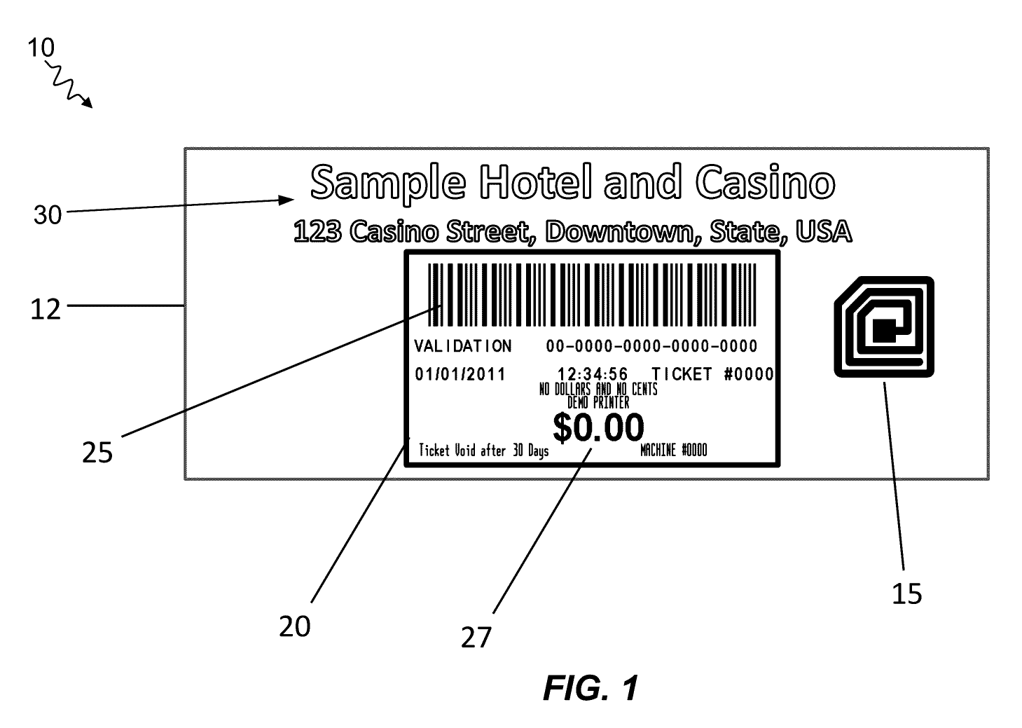

With reference to FIG. 1 and according to one embodiment of the present invention, the electronic ticket-in ticket-out voucher (e-TITO voucher) 10 is shown in greater detail. The e-TITO voucher 10 is primarily comprised of a transport medium 12, a Radio Frequency Identification (RFID) tag 15 to wirelessly provide a unique ticket identifier, an electronic display 20 to dynamically display ticket information such as a bar coded validation number 25 and casino artwork 30, as well as a contact surface (not shown) to electrically connect the electronic display 20 to a programing and reading module (not shown) further described below. In one embodiment of the present invention, the e-TITO transport medium 12 consists of a flexible polymer material. A worker skilled in the relevant art would be familiar with other transport mediums which allow for repeated uses and for the incorporation of the elements of the present voucher. The e-TITO voucher 10 electronic display 20 is described as comprising of a flexible E-ink paper media technology. E-ink paper comprised of a thin film containing ink microcapsules that rearrange to form graphics based on an electric current. A worker skilled in the art would understand the functionality and use of flexible E-ink paper and would appreciate other mediums can be interchanged with E-ink paper, such as a liquid crystal display paired with a photovoltaic solar panel. The electronic display 20 will display mandatory information to operate within the existing TITO environment: date; ticket number; machine number; voucher amount 27; and, bar code 25. The e-TITO voucher 10 can be programmed to display the current value on the electronic display 20 by placing the e-TITO voucher 10 on a programming and reading module (not shown). The programming and reading module (not shown) would pass a unique electric current through to the electronic display 20, thereby rearranging the E-ink microcapsules to display the information described above including voucher value 27 and a bar coded validation 25. After the current is passed through the electronic display 20, the E-ink microcapsules would remain in said position until another current is passed through the electronic display 20 which would rearrange the E-ink microcapsules. As such, the e-TITO voucher 10 would require no energy or very little energy to display the voucher value 27 and the bar coded validation number 25. By verifying the RFID tag 15, the gaming establishment's servers can ensure that the e-TITO voucher 10 is authentic, was issued by the gaming establishment, and contains the corresponding value. The primary function of the electronic display 20 is to interact with the current TITO system by means of the barcode 25, and to indicate to the user the e-TITO voucher amount. The e-TITO voucher 10 is operable even when the electronic display 20 is inoperable due to a malfunction on damage as the RFID tag 15 can still communicate its value to the gaming machine, which will then pass on this information to the gaming establishment's servers as further described below. In this embodiment, the e-TITO voucher 10 provides low maintenance cost, decreased material cost per usage, ease of use by the player, and environmentally conscious. The gaming establishment reduces labor cost as the e-TITO voucher 10 eliminates the need to continually replenish paper required for printed TITO, and regular removal of cash from individual gaming machines. As each player will use only one e-TITO voucher 10, the electronic in-ticket out-ticket system will decrease material cost per usage, and is environmentally conscious.

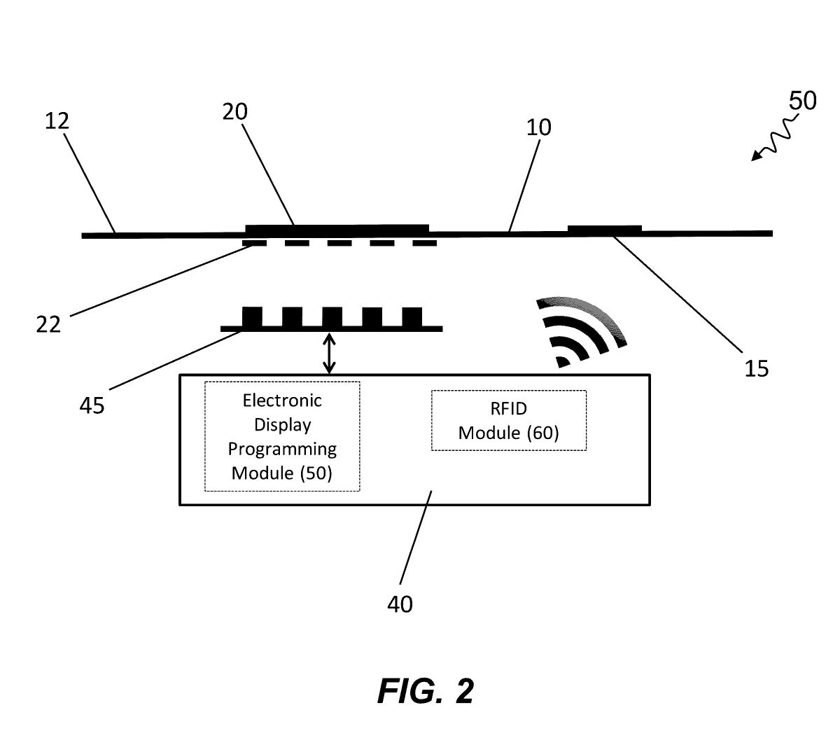

With reference to FIG. 2 and according to one embodiment of the present invention a representative schematic of the e-TITO voucher 10 interacting with a programming and reading module 40 is described in greater detail. The electronic display 20 of the e-TITO voucher 10 is programmed by an electronic programming and reading module 40 through a series of electronic display contact pads 45. The electronic display contact pads 45 of the programming and reading module 40 come into contact with the electronic display contact surface 22 located on the underside of the e-TITO voucher 10. The contact surface 22 is comprised of a first and second end (not shown), wherein the first end is electrically connected to the electronic display 20 to send display instructions as described above, while the second end is removably electrically connected to the contact pads 45 of the programming and reading module 40 to receive display instructions therefrom, as explained above. Upon contact, the programming contact pads 45 pass an electrical current which is relayed from the electronic display contact surface 22 to the electronic display 20. The current which is passed to the electronic display 20 varies, as every time a player wishes to ticket-out the electronic display 20 will have a different date, ticket number, machine number, voucher amount and bar code. The current that passes to the electronic display 20 will be predetermined and set when the user decides to ticket-out from the gaming station (not shown). In addition to passing the current through the programming contact pads 45, the programming and reading module 40 reads or sends a signal to the RFID tag 15 when the e-TITO voucher 10 is used to ticket-in or ticket-out, respectively. Through the use of electronic display 20, once a ticket is programmed by the programming and reading module 40 the e-TITO voucher 10 does not need power to display the information to the player. Also, having the microprocessor controlling the display outside the e-TITO voucher 10 and in the programming and reading module 40 reduces the complexity and price of the individual e-TITO voucher 10.

To employ the electronic ticket-in ticket-out system 50 the gaming establishment would be required to replace the TITO printer units on each gaming machine with a unit comprising of a stack of e-TITO vouchers 10, a carrying mechanism, and an e-TITO apparatus shell (not shown) to house the e-TITO programming and reading module 40. Due to the placement of the bar code 25 on the e-TITO voucher 10, the electronic ticket-in ticket-out system 50 will be able to work with the current TITO systems, thereby minimizing the cost and the transition period for gaming establishments. When a player inserts the e-TITO voucher 10 into an existing gaming machine (not shown), the existing scanner in the gaming machine (not shown) scans the barcode on the voucher 10. If the barcode reads a certain value, currently “0000”, the gaming machine (not shown) will know to activate the RFID module 60 and read the RFID tag 15 on the voucher 10 in order to determine the unique identifier of the voucher 10. The gaming machine will then ping the existing server in order to determine the amount of monies associated with the unique identifier as provided by the RFID tag 15. Once a player choses to leave a gaming machine (not shown), said gaming machine (not shown) would send a signal to the centralized casino server in order to update the internal records with the new monies remaining associated with this unique identifier. Concurrently, the gaming machine (not shown) will send a signal to the electronic display programming module 40 which will contain the remaining monies as described above. These instructions will be forwarded through the contact pads 45 and to the contact surface 22 of the voucher 10. The contact surface 22 will send corresponding instructions to the electronic display 20 in order to display the updated amount for the benefit of the user.

In another embodiment, the e-TITO voucher 10 would have a fixed bar boded ticket validation number, located outside of the electronic display 20, comprising of a unique number not being used by the existing TITO system. This unique number would trigger the e-TITO programming and reading module 40 to read the RFID tag 15 instead of the bar code 25. In yet another embodiment, the e-TITO voucher can be used on gaming machines containing bill validators. Most bill validators in the gaming machines contain an integrated RFID tag reader, which can be employed to read the RFID tag 15 on the e-TITO voucher 10.

The various features of the invention described herein can be implemented in different systems without departing from the invention. It should be noted that the foregoing embodiments of the disclosure are merely examples and are not to be construed as limiting the invention. The description of the embodiments of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. An electronic ticket voucher comprising:
a. an electronic display to dynamically display ticket information;
b. a radio frequency identification tag to wirelessly communicate a unique ticket identifier; and
c. a contact surface comprising:
i. a first end electrically connected to the electronic display to send display instructions; and,
ii. a second end to provide an electrical connection to a programming and reading module to receive display instructions.

2. The electronic ticket voucher of claim 1, wherein the ticket information comprises at least a barcode and a balance amount.

3. The electronic ticket voucher of claim 1, wherein the electronic ticket voucher is made of a flexible polymer material.

4. An electronic ticket-in and ticket-out system for use in a gaming machine comprising:
a. an electronic ticket voucher comprising:
i. an electronic display to dynamically display ticket information; and,
ii. a radio frequency identification tag to wirelessly communicate a unique ticket identifier;
b. a programming and reading module electrically connected to the ticket voucher and the gaming machine to receive information from the gaming machine and instruct the voucher to display corresponding ticket information; and,
c. a radio frequency identification module in wireless communication with the radio frequency identification tag to receive the unique ticket identifier and relay the unique ticket identifier to the gaming machine.

5. The electronic ticket-in and ticket-out system of claim 4, wherein the programming and reading module comprises contact pads.

6. The electronic ticket-in and ticket-out system of claim 4, wherein the electronic ticket voucher, programming and reading module, and radio frequency identification module are fitted into an electronic ticket-in ticket-out apparatus shell into the gaming machine.
